(19) United States
(12) Patent Application Publication
(10) Pub. No.: US 2012/0179754 A1
(43) Pub. Date: Jul. 12, 2012

(54) SYSTEM AND METHOD FOR DEVICE APPLICATION AND/OR APPLICATION PROGRAMMING INTERFACE DISCOVERY

(76) Inventors: Claes Nilsson, Lund (SE); Anders Isberg, Lund (SE)

(21) Appl. No.: 13/259,511

(22) PCT Filed: Dec. 29, 2010
(86) PCT No.: PCT/IB10/03345

§ 371 Date: Sep. 23, 2011

(51) Int. Cl. G06F 15/16

(52) U.S. Cl. 709/204

(57) ABSTRACT

A system and method for discovering one or more associated sensors 3 with an electronic device 10 includes detecting one or more associated sensors in proximity of the electronic device, wherein the one or more associated sensors include a web address 4 for downloading computer code from a remote server 64 and the one or more associated sensors are operative to transmit sensor data to the electronic device; storing the address in memory 18 of the electronic device; invoking a web application to access the computer code at the remote server; executing the received computer code in order to establish an interface between with the one or more associated sensors and the electronic device; and receiving sensor data from the one or more associated sensors.

### TECHNICAL FIELD OF THE INVENTION

The present invention relates generally to electronic equipment that may be used to communicate with one or more electronic devices and, more particularly, to a system and method for discovering an application and/or an application programming interface to facilitate communication between the electronic equipment and the electronic device.

### DESCRIPTION OF THE RELATED ART

Portable communication devices are becoming increasingly popular. For example, digital cameras, mobile telephones and portable media players are now in wide-spread use. In addition, the features associated with certain types of portable communication devices have become increasingly diverse. To name a few examples, many portable electronic devices have cameras, text messaging capability, multimedia messaging capability, Internet browsing functionality, electronic mail capability, video playback capability, audio playback capability, image display capability and hands-free headset interfaces.

It is often desirable for a portable communication device to communicate with sensors and/or sensor networks. However, the number and types of sensors are rapidly increasing and there is no conventional method to dynamically add new sensors without requiring standardization of application programming interfaces, which is undesirable.

### SUMMARY

There is a need in the art for a system and method to make new device applications and/or application programming interfaces (APIs) available in such a manner that does not require standardization of the APIs tailored to each new sensor.

One aspect of the invention relates to a method for discovering an application and/or an application programming interface for establishing an interface between an electronic device and/or one or more other electronic devices, the method including: detecting one or more other electronic devices in proximity of the electronic device, wherein the one or more other electronic devices include an address for downloading computer code from a remote server and the one or more other electronic devices are operative to transmit data to the electronic device; storing the address in memory of the electronic device; invoking a web user agent to access the computer code stored at the address; executing the received computer code in order to establish an interface between with the one or more other electronic devices and the electronic device; and transmitting information to the one or more other electronic devices and/or receiving information from the one or more other electronic devices.

Another aspect of the invention relates to coupling the electronic device to an Internet-enabled device.

Another aspect of the invention relates to when the electronic device is coupled to the Internet-enabled device, the electronic device detects if one or more of the other electronic devices are in proximity.

Another aspect of the invention relates to the Internet-enabled device is coupled to the electronic device through a wired cable medium.

Another aspect of the invention relates to the cable medium a universal serial bus cable.

Another aspect of the invention relates to the Internet-enabled device coupled to the electronic device through a wireless communication protocol.

Another aspect of the invention relates to the wireless communication protocol is at least one selected from the group consisting of: Bluetooth, near field communication, ANT+, BLE, Zigbee and 802.11-enabled communication protocols.

Another aspect of the invention relates to including presenting a query to an associated user prior to invoking the web user agent to access the computer code at the remote server.

Another aspect of the invention relates to the computer code is in a form of a Java script library.

Another aspect of the invention relates to the address is a uniform resource locator (URL).

Another aspect of the invention relates to the address is an Internet Protocol address.

Another aspect of the invention relates to the computer code is a form of a web application for execution on the electronic device.

One aspect of the invention relates to an electronic device including: a memory configured to store one or more computer applications to facilitate communication between the electronic device and one or more associated electronic devices; a wireless adapter configured to communicate with the one or more associated electronic devices in a wireless manner; a processor coupled to the memory and the wireless adapter, wherein when the one or more associated electronic devices are within proximity of the electronic device, the processor is configured to: detect the one or more associated electronic devices in proximity of the electronic device, wherein the one or more associated electronic devices include an address for downloading computer code from a remote server and the one or more associated electronic devices are operative to transmit data to the electronic device; storing the address in memory of the electronic device; invoking a web user agent resident on the electronic device to access the computer code stored at the address; executing the received computer code in order to establish an interface between with the one or more associated electronic devices and the electronic device; and transmitting information to the one or more other electronic devices and/or receiving information from the one or more other electronic devices.

Another aspect of the invention relates to including a wired cable medium for coupling the electronic device to the one or more associated electronic devices.

Another aspect of the invention relates to the cable medium a universal serial bus cable.

Another aspect of the invention relates to including a wireless communication adapter for coupling the electronic device to the one or more associated electronic devices through a wireless communication protocol.

Another aspect of the invention relates to the wireless communication protocol is at least one selected from the group consisting of: Bluetooth, near field communication, ANT+, BLE, Zigbee and 802.11-enabled communication protocols.

Another aspect of the invention relates to the computer code is in a form of a Java script library.

Another aspect of the invention relates to the address is a uniform resource locator (URL).

Another aspect of the invention relates to the address is an Internet Protocol (IP) address.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments. It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an exemplary system in accordance with aspect of the present invention.

FIG. 2 is a schematic view of a portable communication in accordance with an embodiment of the present invention.

FIG. 3 is a schematic block diagram of the relevant portion of the portable communication device of FIG. 2 in accordance with an embodiment of the present invention.

FIG. 4 is another exemplary system in accordance with aspects of the present invention.

FIG. 5 is a flow chart of an exemplary method in accordance with embodiments of the present invention.

FIG. 6 is an exemplary system illustrating a use case in accordance with aspects of the present invention.

FIG. 7 is another exemplary system in accordance with another embodiment of the present invention.

### DETAILED DESCRIPTION OF EMBODIMENTS

The present invention will now be described with reference to the drawings, wherein like reference numerals are used to refer to like elements throughout. It will be understood that the figures are not necessarily to scale.

The term “electronic device” refers to any type of electronic device. For example, electronic device may be used herein to refer to a mobile telephone, portable communication device, computer, computing device, sensor, actuator, portable radio communication equipment, etc. The term “portable radio communication equipment,” which herein after is referred to as a “mobile radio terminal,” includes all equipment such as mobile telephones, pagers, communicators, electronic organizers, personal digital assistants (PDAs), smartphones, portable communication devices or the like.

In the present application, the invention is described primarily in the context of a mobile telephone. However, it will be appreciated that the invention is not intended to be limited to a mobile telephone and can be any type of appropriate electronic device.

The present invention relates generally to electronic equipment that may be used to communicate with one or more other electronic devices (e.g., sensors, actuators, or any other physical resource) that are operable to communicate with an Internet-connected computing device. In particular, the invention relates to a system and method for discovering an application and/or an application programming interface to facilitate communication between the electronic equipment and the other electronic devices. For purposes of clarity, the specification may use the terms “sensor” and/or “actuator” to distinguish between electronic devices. One of ordinary skill in the art will readily appreciate that the terms “sensor” and/or “actuator” refer to any type of electronic device and should be interpreted broadly, as such.

One aspect of the present invention enables dynamically adding new sensors, actuators, or other physical resource to be coupled to an electronic equipment without resorting to customized APIs for each electronic device. As used herein, the phrase “web application” means a computer software application that is accessed via a web user agent (e.g., a web browser) over a network such as the Internet or an intranet.

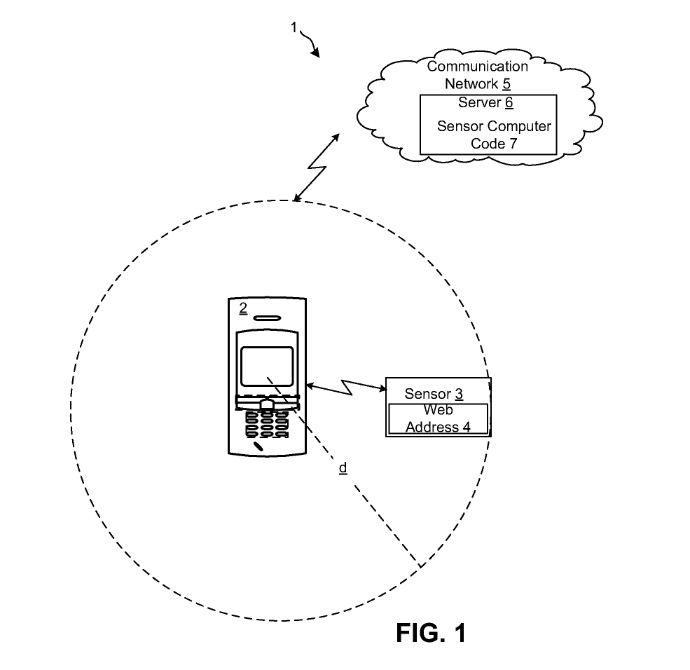

An exemplary system 1 in accordance with aspects of the present invention is illustrated in FIG.1. As illustrated in FIG. 1, the system 1 includes an electronic device 2; an electronic device 3 (e.g., sensor, actuator, etc.) having a web address 4 stored therein; a communication network 5; and a remote server 6, which is operable to store sensor computer code 7. In general operation, when the sensor 3 is in proximity of the electronic device 2, the sensor 3 can be discovered by the electronic device 2. As discussed below, any type of discovery protocol may used in accordance with aspects of the present invention. When the sensor 3 is discovered a web address 4 (e.g., a uniform resource locator (URL), IP address, etc.) is transferred from the sensor 3 to the electronic device 2. The web address 4 may refer to a web page that provides a web application or a library of application program interfaces (APIs) for use with the sensor 3.

A web user agent stored on the electronic device 2 (or an Internet-enabled device coupled to a non-Internet enabled electronic device) is invoked and connects to server 6, which corresponds to the web address 4 provided from the sensor 3. Sensor computer code 7 stored on the server 6 may be downloaded to and stored on the electronic device 2 through a web user agent stored on the electronic device 2. Upon execution of the sensor computer code 7 on the electronic device 2, the electronic device is operable to communicate (e.g., receive and/or transmit signals) with the sensor 3. Such communication may include transmitting information to the one or more other electronic devices and/or receiving information from the one or more other electronic devices. For example, the electronic device 2 may transmit commands, data or other information to the sensor 3 and/or receive commands, data or other information from the sensor 3.

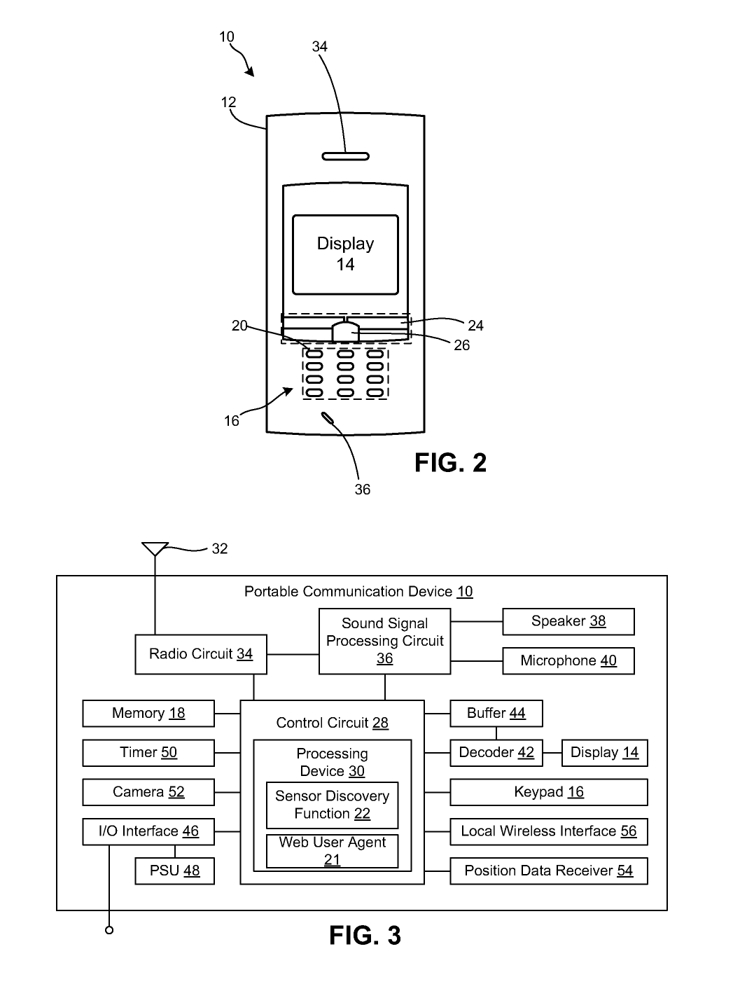

Aspects of the invention will now be discussed in greater detail. Referring to FIG. 2, a portable communication device 10 is shown in accordance with aspects of the present invention. The portable communication device 10 is identical to the electronic device 2 referred to above. Again, for purposes of clarity the invention is illustrated with a portable communication device. The portable communication device 10 may be any type of electronic device including, for example, a computer, a laptop, a tablet, a personal digital assistant, television, mobile telephone, etc.

The portable communication device 10 includes a web user agent 21 (e.g., Internet browser) (FIG. 3) and is an Internet-enabled device. For purposes of this disclosure the phrase “Internet-enabled device” means that the electronic device is capable of directly connecting to the Internet through a mobile communications network, an 802.11-compliant protocol (e.g., WiFi, WiMax, etc.) or other communication protocol. Aspects of the present invention are also applicable to non-Internet-enabled devices and are discussed below. Exemplary web user agents 21 include, e.g., Internet Explorer, Safari, Chrome, Firefox, Opera, etc. In general, a web user agent 21 is useful for bringing information resources to the user of the portable communication device 10. In general operation, a user inputs a Uniform Resource Identifier (URL), for example http://www.sonyericsson.com/, into the web user agent 21. The prefix of the URL determines how the URL will be interpreted. The most commonly used URL starts with http: and identifies a resource to be retrieved over the Hypertext Transfer Protocol (HTTP). Many browsers also support a variety of other prefixes, such as https: for Hypertext Transfer Protocol secure; ftp: for the File Transfer Protocol, and file: for local files. In the case of http, https, file, and others, once the resource has been retrieved by the web user agent 21, the contents of the resource will be presented on a display associated with the web user agent 21.

Generally, the content is present in hypertext markup language (HTML) that is passed to the browser's layout engine to be transformed from markup to an interactive document, which may be presented to a user on display 14, for example. Aside from HTML, web browsers can generally display any kind of content that can be part of a web page. Most browsers can display images, audio, video, and XML files, and often have plug-ins to support Flash applications and Java applets. Upon encountering a file of an unsupported type or a file that is set up to be downloaded and/or executed rather than displayed, the browser may prompt the user to save the file to disk and/or execute the file.

Interactivity in a web page can also be supplied by JavaScript, which usually does not require a plug-in. JavaScript can be used along with other technologies to allow “live” interaction with the web page's server via asynchronous JavaScript (AJAX), for example.

Information resources may contain hyperlinks to other information resources. Each link contains the URL of a resource to go to. When a link is clicked, the browser navigates to the resource indicated by the link's target URL, and the process of bringing content to the user begins again.

The portable communication device 10 is shown as having a “brick” or “block” form factor housing 12, but it will be appreciated that other type housings, such as a clamshell housing or a slide-type housing, may be utilized without departing from the scope of the invention.

The portable communication device 10 includes a display 14 and keypad 16. As is conventional, the display 14 displays information to a user such as operating state, time, telephone numbers, contact information, various navigational menus, etc., which enable the user to utilize the various feature of the portable communication device 10. The display 14 may also be used to visually display content received by the portable communication device 10 and/or retrieved from a memory 18 (FIG. 3) of the portable communication device 10. The display 14 may also be used as a viewfinder to support camera and/or video functions associated with the portable communication device 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys 24 such as a “call send” key for initiating or answering a call, and a “call end” key for ending or “hanging up” a call. Special function keys may also include menu navigation keys 26, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The portable communication device 10 includes conventional call circuitry that enables the portable communication device 10 to establish a call and/or exchange signals with a called/calling device, typically another mobile telephone or landline telephone. However, the called/calling device need not be another telephone, but may be some other device such as an Internet web server, content providing server, etc.

FIG. 3 represents a functional block diagram of the portable communication device 10. With the exception of sensor discovery function, which is preferably implemented as executable logic in the form of application software or code within the portable communication device 10, the construction of the portable communication device 10 is otherwise generally conventional. The portable communication device 10 includes a primary control circuit 28 that is configured to carry out overall control of the functions and operations of the portable communication device 10. The control circuit 28 may include a processing device 30, such as a CPU, microcontroller or microprocessor. The processing device 30 executes code stored in a memory (not shown) within the control circuit 28 and/or in a separate memory, such as memory 18, in order to carry out conventional operation of the portable communication device 10. The memory 18 may be, for example, one or more of a buffer, a flash memory, a hard drive, a removable media, a volatile memory, a non-volatile memory or other suitable device. In addition, the processing device 30 executes code in order to perform the sensor discovery function 22 and stores and/or executes any files downloaded from the Internet or other source, for example.

It will be apparent to a person having ordinary skill in the art of computer programming, and specifically in applications programming for mobile telephones or other items of electronic equipment, how to program a portable communication device 10 to operate and carry out the functions described herein. Accordingly, details as to the specific programming code have been left out for sake of brevity. Also, while the sensor discovery function 22 is executed by the processing device 30 in accordance with the preferred embodiment of the invention, such functionality could also be carried out via dedicated hardware, firmware, software, or combinations thereof, without departing from the scope of the invention.

Continuing to refer to FIGS. 2 and 3, the portable communication device 10 includes an antenna 32 coupled to a radio circuit 34. The radio circuit 34 includes a radio frequency transmitter and receiver for transmitting and receiving signals via the antenna 32, as is conventional. The radio circuit 34 may be configured to operate in a mobile communications system, as well as to receive audiovisual content. For example, the receiver may be an IP datacast compatible receiver compatible with a hybrid network structure providing mobile communications and DVB-H based or similar services. Other receivers for interaction with a mobile radio network or broadcasting network are possible and include, for example, GSM, CDMA, WCDMA, MBMS, WiFi, WiMax, DVB-H, ISDB-T, etc.

The portable communication device 10 further includes a sound signal processing circuit 36 for processing audio signals transmitted by/received from the radio circuit 34. Coupled to the sound processing circuit 36 are a speaker 38 and a microphone 40 that enables a user to listen and speak via the portable communication device 10, as is conventional. The radio circuit 34 and sound processing circuit 36 are each coupled to the control circuit 28 so as to carry out overall operation.

The portable communication device 10 also includes the aforementioned display 14 and keypad 16 coupled to the control circuit 28. The display 14 may be coupled to the control circuit 28 by a video decoder 42 that converts video data to a video signal used to drive the display 14. The video data may be generated by the control circuit 28, retrieved from a video file that is stored in the memory 18 or derived from an incoming video data stream received by the radio circuit 34. Prior to being feed to the decoder 42, the video data may be buffered in a buffer 44.

The portable communication device 10 further includes one or more I/O interface(s) 46. The I/O interface(s) 46 may be in the form of typical mobile telephone I/O interfaces and may include one or more electrical connectors. As is typical, the I/O interface(s) 46 may be used to couple the portable communication device 10 to a battery charger to charge a battery of a power supply unit (PSU) 48 within the portable communication device 10. In addition, or in the alternative, the I/O interface(s) 46 may serve to connect the portable communication device 10 to a wired personal hands-free adaptor (not shown). Further, the I/O interface(s) 46 may serve to connect the portable communication device 10 to a personal computer or other device via a data cable. The portable communication device 10 may receive operating power via the I/O interface(s) 46 when connected to a vehicle power adapter or an electricity outlet power adapter.

The portable communication device 10 may also include a timer 50 for carrying out timing functions. Such functions may include timing the durations of calls, generating the content of time and date stamps, etc. The portable communication device 10 may include a camera 52 for taking digital pictures and/or movies. Image and/or video files corresponding to the pictures and/or movies may be stored in the memory 18.

The portable communication device 10 also may include a position data receiver 54, such as a global positioning system (GPS) receiver, Galileo satellite system receiver or the like. The portable communication device 10 also may include a local wireless interface 56, such as an infrared transceiver and/or an RF adaptor (e.g., a Bluetooth adapter, WiFi adapter, NFC adapter, etc.), for establishing communication with an accessory, hands-free adaptor, another mobile radio terminal, computer, communication network or other device.

The portable communication device 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video, executable files, JavaScript, and so forth. Processing such data may include storing the data in the memory 18, executing applications to allow user interaction with data, displaying video and/or image content associated with the data, broadcasting audio sounds associated with the data and so forth.

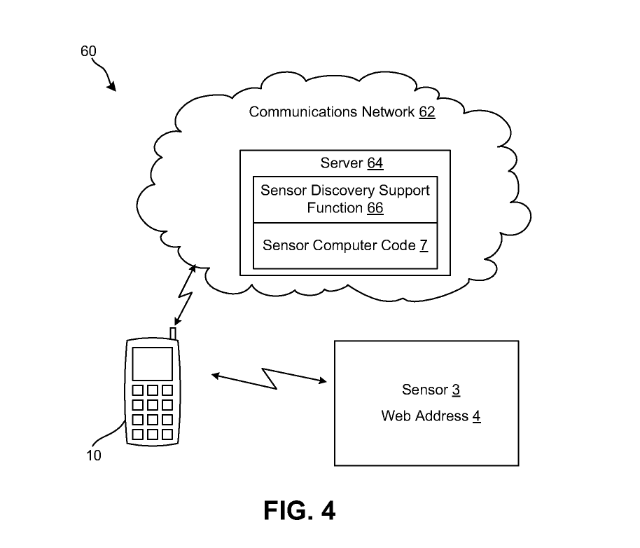

With additional reference to FIG. 4, an exemplary communications system 60 in accordance with aspects of the present invention is illustrated. The communications system 60 is configured to facilitate communications with the portable communication device 10 and/or any other device communicatively coupled to the communications system 60 through communications network 62. The communications network 62 includes one or more servers 64 for managing communication services between devices coupled to the network 62. The one or more servers 64 further includes third party servers that are operable to store web applications and/or one or more high level JavaScript application interface libraries, for example. Collectively, the web applications and the one or more high level JavaScript application interface libraries may be referred to herein as “sensor computer code” (e.g., sensor computer code 7).

The communications network 62, through the one or more servers 64, is operable to receive communication requests (e.g., request to download an application, requests to access a JavaScript library, etc.) and to establish a communication session between the requesting portable communication device and the target server 64 (e.g., a third party server)

The one or more servers 64 are operable to communicate with the portable communication devices 10 via a transmission medium. The transmission medium may be any appropriate device or assembly, including, for example, a communications tower, another portable communication device, a wireless access point, a satellite, etc. Portions of the network may include wireless and/or wired transmission pathways.

As stated above, the one or more servers 64 are configured to establish a logical connection between a requesting portable communication device 10 and a third party server. In one embodiment, the one or more servers 64 may operate in a standalone configuration relative to other servers of the network 62 or may be configured to carry out multiple communications network functions. As will be discussed below, the server 64 may be configured as a typical computer system used carry out server functions and may include a processor configured to execute software containing logical instructions that embody the functions of the server 64. Those functions may include functions that are complimentary to the operation of a sensor discovery function 22 of the portable communication device 10 and will be collectively referred to as a sensor discovery support function 66, which may or may not include the sensor computer code 7.

As described in detail below, the sensor discovery support function 66 is operable to process requests received from the portable communication device 10 and transmit a web application and/or a JavaScript API library to the portable communication, which may be used to facilitate communication between the sensor and the portable communication device 10.

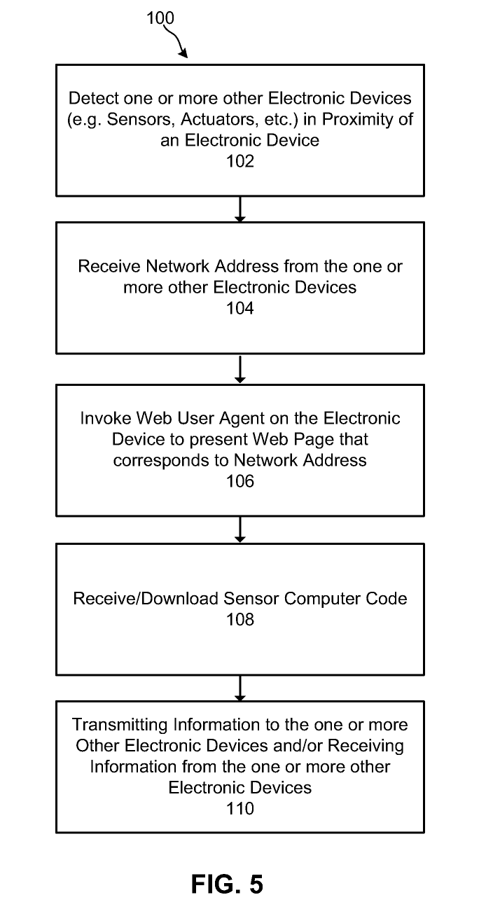

Referring to FIG. 5, a flow chart illustrating an exemplary method 100 for discovering one or more associated sensors with an electronic device (e.g., portable communication device 10) is shown. The flow chart may be thought of as depicting steps of a method caused to be performed by the sensor discovery function 22. Although FIG. 5 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method 100 may be used to discover any type of electronic device, including, for example sensor(s) and/or actuator(s), which may be used for any purpose. In one aspect of the invention, the sensor 3 may be a temperature sensor, medical sensors (e.g., blood sugar sensors, blood pressure sensors, blood oxygenation sensors, skin conductivity sensors, temperature sensors, chemical sensors, etc.), physical training sensors (e.g., heart rate monitor, pedometer, global positioning tracking device, etc.), context aware sensors (e.g., location sensors, air pressure sensors, facial recognition sensors, etc.), intelligent home sensors (e.g., safety sensors, fire alarms, indoor temperature, security system, garage door, etc) and the like.

One of ordinary skill in the art will readily appreciate that any wired and/or wireless communication protocol may be used in accordance with aspects of the present invention. Exemplary communication protocols include, for example, universal serial bus (USB), Bluetooth, Bluetooth Low Energy (BLE), ANT+, Zigbee, etc.

The exemplary method 100 may be initiated by one or more users positioning a portable communication device 10 within an operable distance “d” (shown in FIG. 1) from a sensor 3. As appreciated by a person having ordinary skill in the art the operable distance may vary based on the mode of communication between the portable communication device 10 and the sensor 3. For example, if the mode of communication is near field communication (NFC), the portable communication device must be within a few centimeters of the sensor in order to facilitate NFC. If the mode of communication is Bluetooth, the portable communication device 10 may be within 30 feet, for example.

Bluetooth technology provides a manner in which many wireless devices may communicate with one another, without connectors, wires or cables. A wireless interface commonly used in headsets and mobile telephones is referred to as

“Bluetooth” technology. Bluetooth refers to a technical specification designed to standardize wireless transmission between a wide variety of electronic devices, such as personal computers, mobile telephones, cordless telephones, headsets, printers, personal digital assistants (“PDAs”), etc. Bluetooth acts as a “virtual cable”, whereby one electronic device can easily communicate with another electronic device. Bluetooth technology uses the free and globally available unlicensed 2.4 GHz radio band, for low-power use, allowing two Bluetooth devices within a range of up to 10 to 100 meters (also referred to herein as “operable distance”) to share data with throughput up to 2.1 Mbps. Each Bluetooth device can simultaneously communicate with many other devices.

Before two Bluetooth enabled devices may communicate, the devices generally are paired. Bluetooth pairing occurs when the two Bluetooth enabled devices become a trusted pair. Conventionally, to become a trusted pair, two Bluetooth devices would first complete a specific discovery and authentication process. When a first Bluetooth device recognizes a second Bluetooth device and complete a specific discovery and authentication process, each device can automatically accept communication between them.

Device discovery is the procedure a Bluetooth wireless device uses to locate nearby Bluetooth wireless devices with which it wishes to communicate. Exchanging the Bluetooth addresses of the discoverable devices, their friendly names and other relevant information via establishing a short term connection with each device in the vicinity can be a time consuming procedure. The procedure can involve having one Bluetooth wireless device transmitting an inquiry request to other Bluetooth wireless devices scanning for inquiry requests. A device that transmits the inquiry request (a potential master) is said to be discovering devices while the device that is scanning for inquiry requests is said to be discoverable. The discoverable device (a potential slave) performs a process called inquiry scanning, during which it looks for an inquiry request. Once a discoverable device receives an inquiry request, it responds with Frequency Hopping Synchronization (FHS) packets. These packets include, among other fields, the discoverable device's 6-byte Bluetooth device address and 3-byte Class of Device (COD). The list of the discovered devices is then presented to the user. The user may select the desired device to be paired with.

During the device discovery procedure, it is possible to obtain further information from discoverable devices such as the Bluetooth device-friendly names.

To do this the discovering device sends a page request to the discovered device's Bluetooth device address(es), at which point the discovering device initiates a short term connection with the discoverable device(s) and becomes a master. When a discoverable device responds to a page request, it becomes a slave. At this point, the devices are not paired, but the master can send a request for the slave's friendly name. For example, the friendly name may look like “Bluetooth Headset”.

Typically instead of the hexadecimal Bluetooth addresses the list of devices' friendly names is presented to the user at the end of the discovery procedure. At this moment the user can select the Bluetooth wireless device he or she desires to start the communication with. After the user makes a selection, the discovering device can initiate a connection with the newly discovered device using the discovered device's Bluetooth device address. Without device discovery a Bluetooth wireless device would not know the Bluetooth device address of other Bluetooth devices that is required information for establishing a connection between the devices.

During the discovery process, the devices are generally in discovery mode. There may be a toggle, switch or other setting mechanism for making the devices either discovering or discoverable ones.

Prior to portable communication device 10 establishing a wireless communication link to the one or more sensors 3, the electronic device typically requires computer code containing information related to the sensor in order to facilitate communication between the portable communication device 10 and the one or more sensors 3. A person having ordinary skill in the art will appreciate that the exemplary method 100 described may be modified to take into account one or more different communication modes.

At block 102, one or more associated sensors 3 in proximity of the portable communication device 10 are detected. The one or more sensors 3 include a web address (e.g., a web address, URL, IP address, etc.) that corresponds to a website for downloading computer code associated with the sensor (e.g., sensor computer code 7) from a server. One of ordinary skill in the art will appreciate that the web address may be stored in type of memory associated with the sensor. For example, the web address may stored in a radio frequency identification (RFID) tag, a non-volatile memory, a read only memory, random access memory (RAM), an electrically erasable programmable read-only memory (EEPROM), and the like.

The sensor computer code 7 may be a complete web application that was written specifically for use with the sensor 3 and/or a JavaScript API library that is tailored by a user or third party for use with the sensor 3. When properly downloaded and executed by the portable communication device 10, the sensor computer code 7 is operable to facilitate communication between the one or more associated sensors 3 and the portable communication device 10. Such communication may include transmitting sensor data to the portable communication device, transmitting user input from the portable communication device to the sensor, transmitting commands from the portable communication device 10 to the one or more sensors 3, for example.

At block 104, the network address provided by the sensor is stored in a memory 18 of the portable communication device 10. The web address may be temporarily and/or permanently in memory 18, for example.

At block 106, the user may be presented with an option to invoke a web user agent 21 to access the sensor computer code 7 at the server 64. For example, a web user agent 21 (e.g., a web browser application) may be invoked and the address provided from the sensor 3 may be loaded into the web user agent 21. The web user agent 21 typically presents the contents of the corresponding web page on a display 14 of the portable communication device 10. The web user agent 21 may be invoked automatically or a query may be presented to an associated user on display 14 of the electronic device prior to invoking the web application to access the sensor computer code 7 at the server 64.

At block 108, the received sensor computer code 7 is received or otherwise downloaded by the portable communication device 10. The sensor computer code 7 may be executed by the portable communication 10 in order to establish a user interface between with the one or more associated sensors 3 and the portable communication device 10.

As stated above, the sensor computer code 7 may correspond to a web application that was written specifically for use with the sensor 3. In such a case, the sensor computer code 7 may include a complete software application, which includes a user interface as well as computer code to facilitate communication between the portable communication device 10 and the sensor 3, for example. The web application may further include data manipulation tools to record and/or analyze the data received from the sensor, for example.

In another embodiment, the address received by the portable communication device 10 may point to a high level JavaScript API library that is tailored to this specific sensor device. In such case, the user, using the JavaScript API library, may combine one or more high functions provided in the library to customize communication between the portable communication device 10 and the one or more sensor 3, for example. Such customization may include user interface, data storage techniques and/or data manipulation tools.

At block 110, the portable communication device 10 is operable to communicate (e.g., receive and/or transmit signals) with the sensor 3. Such communication may include transmitting information to the one or more other electronic devices and/or receiving information from the one or more other electronic devices. For example, the electronic device 2 may transmit commands, data or other information to the sensor 3 and/or receive commands, data or other information from the sensor 3.

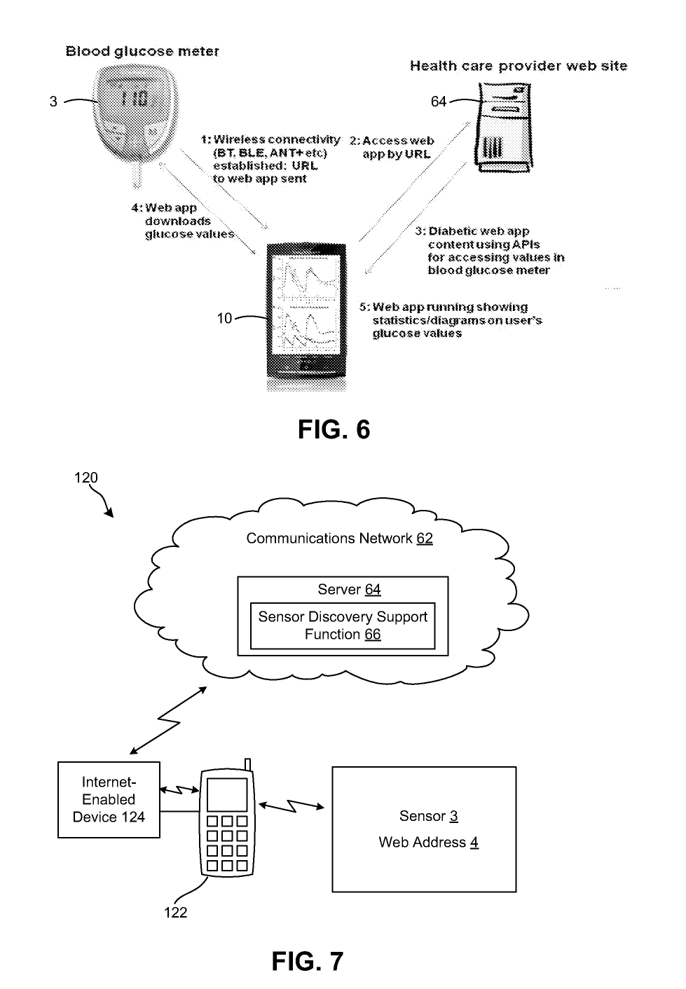

An exemplary system 120 in accordance with aspects of the present invention is illustrated in FIG. 6. The system 120 includes a sensor 3 in the form of a blood glucose meter. The sensor 3 may be wirelessly coupled to the portable communication device 10 by any wireless communication protocol. As set forth above, exemplary communication protocols include, Bluetooth, BLE, ANT+, Zigbee, etc. The sensor 3 includes an address (e.g., URL, IP address, etc.) that is transmitted to the electronic device upon discovery. The portable communication device 10 may invoke a web user agent to access a website hosted by server 64, which corresponds to the address stored by the sensor 3. Sensor computer code 7 stored on the server 64, which is specific to the sensor 3, may then be downloaded to and executed by the portable communication device 10 in order to establish communication between the sensor 3 and the portable communication device 10.

The computer code may be in the form of a specific web application or may be a customizable application that utilizes a JavaScript API library, for example, as discussed above. In this particular example, the computer code may be in the form of web application. Once loaded in and executed by the portable communication device, the web application enables the portable communication device 10 to fully communicate with the sensor 3. For example, the portable communication device 10 executing the web application may then receive and/or process the received sensor data and/or transmit information (e.g., commands, data) to the sensor 3. In addition, the portable communication device 10 may display information associated with the sensor 3 to the user in any desired form (e.g., list form, chart form, graphic form, etc.), store data to memory 18 and/or perform any other desired function. One of ordinary skill in the art will appreciate that the specific capabilities of the computer code may vary based on the sensor 3, portable communication device 10, desired uses of the sensor, and the processing tools provided by the author of the computer code, for example.

One of ordinary skill in the art will also appreciate that while the above discussion assumes that the portable communication device 10 is operable to connect to the Internet directly. In another embodiment 120, illustrated in FIG. 6, the portable communication device may be a non-Internet enabled electronic device 122. In such a case, the communication between the server 64 and the electronic device 122 may require another device 124 to provide an Internet connection between the non-Internet enabled device 120 and the server 64. The connection to the Internet-enabled device 124 may be coupled to the electronic device 122 through a wired cable medium (e.g., a universal serial bus cable). In addition, the Internet-enabled device may be coupled to the electronic device through a wireless communication protocol (e.g., Bluetooth, near field communication, ANT+, BLE, Zigbee and 802.11-enabled communication protocols, etc.). One of ordinary skill in the art will readily appreciate that device 124 may be a computer (or other electronic device) coupled to the Internet, an access point, a wireless router, a modem, etc. Upon connection to the Internet-enabled device, the electronic device 122 may then detect (e.g., discover) if one or more associated sensors are in proximity and/or download the necessary files from the server 64 if the discovery process previously occurred.

The above described invention provides a variety of advantages over conventional methods. For, example, APIs for specific sensor types do not have to be standardized. Only the APIs to access the basic communication channels (USB, Bluetooth, BLE, ANT+, Zigbee, etc.) have to be standardized. In addition, no drivers need to be installed by the end user on the portable communication 10. Once the URL is available all logic required to communicate with the sensor are downloaded from Internet. Furthermore, the memory requirements on the sensor are low, only the URL needs to be stored in the sensor. Software and/or firmware updates may be completed after the sensor is out on the market, since the logic, itself, is not stored in the sensor. The above advantages are exemplary in nature and not intended to limit the scope of the present invention. Other advantages may also become apparent to a person having ordinary skill in the art.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A method for discovering an application and/or an application programming interface for establishing an interface between an electronic device (2, 10) and/or one or more other electronic devices (3), the method comprising:
detecting one or more other electronic devices in proximity of the electronic device, wherein the one or more other electronic devices include an address (4) for downloading computer code (7) from a remote server (6) and the one or more other electronic devices are operative to transmit data to the electronic device;
storing the address in memory (18) of the electronic device;
invoking a web user agent (21) to access the computer code stored at the address;
executing the received computer code in order to establish an interface between with the one or more other electronic devices and the electronic device; and
transmitting information to the one or more other electronic devices and/or receiving information from the one or more other electronic devices.

2. The method of claim 1, further including coupling the electronic device to an Internet-enabled device (124).

3. The method of claim 2, wherein when the electronic device is coupled to the Internet-enabled device, the electronic device detects if one or more of the other electronic devices are in proximity.

4. The method of claim 2, wherein the Internet-enabled device is coupled to the electronic device through a wired cable medium.

5. The method of claim 4, wherein the cable medium a universal serial bus cable.

6. The method of claim 1, wherein the Internet-enabled device coupled to the electronic device through a wireless communication protocol.

7. The method of claim 6, wherein the wireless communication protocol is at least one selected from the group consisting of: Bluetooth, near field communication, ANT+, BLE, Zigbee and 802.11-enabled communication protocols.

8. The method of claim 1, further including presenting a query to an associated user prior to invoking the web user agent to access the computer code at the remote server.

9. The method of claim 1, wherein the computer code is in a form of a Java script library.

10. The method of claim 1, wherein the address is a uniform resource locator (URL).

11. The method of claim 1, wherein the address is an Internet Protocol address.

12. The method of claim 1, wherein the computer code is a form of a web application for execution on the electronic device.

13. An electronic device (2, 10) comprising:
a memory (18) configured to store one or more computer applications to facilitate communication between the electronic device and one or more associated electronic devices (3);
a wireless adapter (56) configured to communicate with the one or more associated electronic devices in a wireless manner;
a processor (30) coupled to the memory and the wireless adapter, wherein when the one or more associated electronic devices are within proximity of the electronic device, the processor is configured to:
detect the one or more associated electronic devices in proximity of the electronic device, wherein the one or more associated electronic devices include an address (4) for downloading computer code from a remote server and the one or more associated electronic devices are operative to transmit data to the electronic device;
storing the address in memory of the electronic device;
invoking a web user agent (21) resident on the electronic device to access the computer code stored at the address;
executing the received computer code in order to establish an interface between with the one or more associated electronic devices and the electronic device; and
transmitting information to the one or more other electronic devices and/or receiving information from the one or more other electronic devices.

14. The electronic device of claim 13, further including a wired cable medium for coupling the electronic device to the one or more associated electronic devices.

15. The electronic device of claim 14, wherein the cable medium a universal serial bus cable.

16. The electronic device of claim 13, further including a wireless communication adapter for coupling the electronic device to the one or more associated electronic devices through a wireless communication protocol.

17. The electronic device of 16, wherein the wireless communication protocol is at least one selected from the group consisting of: Bluetooth, near field communication, ANT+, BLE, Zigbee and 802.11-enabled communication protocols.

18. The electronic device of claim 13, wherein the computer code is in a form of a Java script library.

19. The electronic device of claim 13, wherein the address is a uniform resource locator (URL).

20. The electronic device of claim 13, wherein the address is an Internet Protocol (IP) address.
